(19) United States
(12) Patent Application Publication
(10) Pub. No.: US 2025/0278313 A1
(43) Pub. Date: Sep. 4, 2025

(54) ENERGY-EFFICIENT DEPLOYMENT OF WORKLOADS IN CLOUD COMPUTING SYSTEMS

(71) Applicant: International Business Machines Corporation, Armonk, NY (US)

(72) Inventors: Tatsuhiro Chiba, Bunkyo-ku (JP); Rina Inoue, Sumida-ku (JP); Tamar Eilam, NEW YORK, NY (US); Sunyanan Choochotkaew, Koto (JP); Marcelo Carneiro do Amaral, Tokyo (JP); Eun Kyung LEE, Bedford Corners, NY (US); Huamin Chen, Newton, MA (US)

(21) Appl. No.: 18/591,365

(22) Filed: Feb. 29, 2024

(51) Int. Cl. G06F 9/50

(52) U.S. Cl. CPC G06F 9/5094; G06F 9/5044; G06F 9/505; G06F 9/5072; G06F 2209/503

(57) ABSTRACT

Computer-implemented methods for deploying a workload in a cloud computing system are provided. Aspects include identifying resource utilization levels for processors and memory of each of the plurality of compute nodes, calculating, for each nodes, an idle power level, an activation power level, and a dynamic power level, and identifying characteristics of the workload to be deployed. Aspects also include identifying a plurality of locations that are suitable for deployment of the workload, wherein each of the plurality of locations is one of the plurality of compute nodes, calculating, for each of the plurality of locations based on a simulated deployment of the workload at a corresponding location, an estimated power consumption of the Cloud computing system, and deploying the workload on a first compute node, where the first compute node corresponds to a location associated with a lowest estimated power consumption of the Cloud computing system.

### BACKGROUND

The present disclosure generally relates to Cloud computing systems, and more specifically, to deploying workloads in a Cloud computing system.

Currently, workloads are deployed in a Cloud computing system based on the available computing resources and resource utilization levels of the various compute nodes in the Cloud computing system. Often, workloads are deployed among the compute nodes of the Cloud computing system in a manner designed to evenly distribute the workloads across the compute nodes, such that the resource utilization levels of the compute nodes are approximately equal.

Recently, there has been increased interest in minimizing the energy consumption of Cloud computing systems. One factor driving this interest is regulations requiring the disclosure of a CO₂ footprint for companies. However, current workload scheduling algorithms that are used to deploy and migrate workloads in the Cloud computing systems do not account for the energy efficiency of the placement of workloads within the Cloud computing systems.

### SUMMARY

Embodiments of the present disclosure are directed to computer-implemented methods for deploying workloads in a Cloud computing system. According to an aspect, a computer-implemented method includes identifying resource utilization levels for processors and memory of each of the plurality of compute nodes, calculating, for each of the plurality of compute nodes, an idle power level, an activation power level, and a dynamic power level, and identifying characteristics of the workload to be deployed in Cloud computing system. The method also includes identifying a plurality of locations in the Cloud computing system that are suitable for deployment of the workload based on the characteristics of a workload and the resource utilization levels for processors and memory of each of the plurality of compute nodes, where each of the plurality of locations is one of the plurality of compute nodes, calculating, for each of the plurality of locations based on a simulated deployment of the workload at a corresponding location, an estimated power consumption of the Cloud computing system, and deploying the workload on a first compute node, where the first compute node corresponds to one of the plurality of locations associated with a lowest estimated power consumption of the Cloud computing system.

According to another non-limiting embodiment of the disclosure, a system having a memory having computer-readable instructions and one or more processors for executing the computer-readable instructions, the computer-readable instructions controlling the one or more processors to perform operations. The operations include identifying resource utilization levels for processors and memory of each of a plurality of compute nodes in a Cloud computing system, calculating, for each of the plurality of compute nodes, an idle power level, an activation power level, and a dynamic power level, and identifying characteristics of a workload to be deployed in Cloud computing system. The operations also include identifying a plurality of locations in the Cloud computing system that are suitable for deployment of the workload based on the characteristics of a workload and the resource utilization levels for processors and memory of each of the plurality of compute nodes, where each of the plurality of locations is one of the plurality of compute nodes, calculating, for each of the plurality of locations based on a simulated deployment of the workload at a corresponding location, an estimated power consumption of the Cloud computing system, and deploying the workload on a first compute node, where the first compute node corresponds to one of the plurality of locations associated with a lowest estimated power consumption of the Cloud computing system.

According to another non-limiting embodiment of the disclosure, a computer program product for estimating workload energy consumption is provided. The computer program product includes a computer-readable storage medium having program instructions embodied therewith, the program instructions executable by a processor to cause the processor to perform operations. The operations include identifying resource utilization levels for processors and memory of each of a plurality of compute nodes in a Cloud computing system, calculating, for each of the plurality of compute nodes, an idle power level, an activation power level, and a dynamic power level, and identifying characteristics of a workload to be deployed in Cloud computing system. The operations also include identifying a plurality of locations in the Cloud computing system that are suitable for deployment of the workload based on the characteristics of a workload and the resource utilization levels for processors and memory of each of the plurality of compute nodes, where each of the plurality of locations is one of the plurality of compute nodes, calculating, for each of the plurality of locations based on a simulated deployment of the workload at a corresponding location, an estimated power consumption of the Cloud computing system, and deploying the workload on a first compute node, where the first compute node corresponds to one of the plurality of locations associated with a lowest estimated power consumption of the Cloud computing system.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a block diagram of a Cloud computing system in accordance with one or more embodiments of the present disclosure;

FIG. 3 is a flowchart of a method for deploying a workload in a cloud computing system in accordance with one or more embodiments of the present disclosure; and

FIG. 4 is a flowchart of a method for migrating workloads in a cloud computing system in accordance with one or more embodiments of the present disclosure.

### DETAILED DESCRIPTION

Embodiments of the present disclosure are directed to computer-implemented methods for deploying workloads in a Cloud computing system. According to an aspect, a computer-implemented method includes identifying resource utilization levels for processors and memory of each of the plurality of compute nodes, calculating, for each of the plurality of compute nodes, an idle power level, an activation power level, and a dynamic power level, and identifying characteristics of the workload to be deployed in Cloud computing system. The method also includes identifying a plurality of locations in the Cloud computing system that are suitable for deployment of the workload based on the characteristics of a workload and the resource utilization levels for processors and memory of each of the plurality of compute nodes, where each of the plurality of locations is one of the plurality of compute nodes, calculating, for each of the plurality of locations based on a simulated deployment of the workload at a corresponding location, an estimated power consumption of the Cloud computing system, and deploying the workload on a first compute node, where the first compute node corresponds to one of the plurality of locations associated with a lowest estimated power consumption of the Cloud computing system. Technical benefits of deploying workloads in a Cloud computing system in the manner provided include improving the energy efficiency of the Cloud computing system by determining a deployment location of workloads based at least in part on an estimated total energy consumption of the Cloud computing system.

In addition to the one or more features described herein the idle power level is an amount of power used by a compute node in a standby state during which no workloads are being executed by the compute node. Technical benefits for utilizing the idle power level of compute nodes when deploying workloads in the Cloud computing system include identifying an energy usage impact of deploying a workload to a compute node currently in a standby state.

In addition to the one or more features described herein the activation power level is a minimum amount of power used by a compute node in an active state during which at least one workload is being executed by the compute node and where the activation power level is a constant value that does not vary based on the resource utilization levels for processors and memory of the compute node. Technical benefits for utilizing the activation power of compute nodes when deploying workloads in the Cloud computing system include identifying an energy usage impact of deploying a workload to a compute node currently in an active state.

In addition to the one or more features described herein the dynamic power level is an amount of power used by a compute node in an active state during which at least one workload is being executed by the compute node and where the activation power level is a dynamic value that is dependent upon the resource utilization levels for processors and memory of the compute node. Technical benefits for utilizing the activation power of compute nodes when deploying workloads in the Cloud computing system include identifying an energy usage impact of deploying a workload to a compute node currently in an active state.

In addition to the one or more features described herein the idle power level, the activation power level, and the dynamic power level for each of the plurality of compute nodes is calculated by based on a power consumption of each of the plurality of compute nodes during a standby state and during active states with varying resource utilization levels. Technical benefits for calculating the activation power level and the dynamic power level for each of the plurality of compute nodes include improving the energy efficiency of the Cloud computing system by determining a deployment location of workloads based on the activation power levels and the dynamic power levels of the compute nodes.

In addition to the one or more features described herein the estimated power consumption of the Cloud computing system is calculated as a sum of the idle power level of each of the plurality of the compute nodes operating in a standby state, the activation power level of each of the plurality of the compute nodes operating in an active state and the dynamic power level of each of the plurality of the compute nodes operating in a standby state. In exemplary embodiments, calculating the estimated power consumption of the Cloud computing system based on the idle power level, the activation power level, and the dynamic power level for each compute node and utilizing the estimated power consumption of the Cloud computing system to determine a location for deploying a workload in the Cloud computing system result in a technical benefit of improving the energy efficiency of the Cloud computing system.

In addition to the one or more features described herein the power consumption of the workload is calculated a by evenly dividing the activation power level of the first compute node among workloads being processed by the first compute node and apportioning the dynamic power level among the workloads being processed by the first compute node based on the resource utilization levels of each of the workloads being processed by the first compute node. Technical benefits for dividing the activation power level of the first compute node among workloads being processed by the first compute node and apportioning the dynamic power level among the workloads being processed by the first compute node based on the resource utilization levels of each of the workloads being processed by the first compute node include identifying an accurate power level for each workload.

According to another non-limiting embodiment of the disclosure, a system having a memory having computer-readable instructions and one or more processors for executing the computer-readable instructions, the computer-readable instructions controlling the one or more processors to perform operations. The operations include identifying resource utilization levels for processors and memory of each of a plurality of compute nodes in a Cloud computing system, calculating, for each of the plurality of compute nodes, an idle power level, an activation power level, and a dynamic power level, and identifying characteristics of a workload to be deployed in Cloud computing system. The operations also include identifying a plurality of locations in the Cloud computing system that are suitable for deployment of the workload based on the characteristics of a workload and the resource utilization levels for processors and memory of each of the plurality of compute nodes, where each of the plurality of locations is one of the plurality of compute nodes, calculating, for each of the plurality of locations based on a simulated deployment of the workload at a corresponding location, an estimated power consumption of the Cloud computing system, and deploying the workload on a first compute node, where the first compute node corresponds to one of the plurality of locations associated with a lowest estimated power consumption of the Cloud computing system. Technical benefits of deploying workloads in a Cloud computing system in the manner provided include improving the energy efficiency of the Cloud computing system by determining a deployment location of workloads based at least in part on an estimated total energy consumption of the Cloud computing system.

According to another non-limiting embodiment of the disclosure, a computer program product for estimating workload energy consumption is provided. The computer program product includes a computer-readable storage medium having program instructions embodied therewith, the program instructions executable by a processor to cause the processor to perform operations. The operations include identifying resource utilization levels for processors and memory of each of a plurality of compute nodes in a Cloud computing system, calculating, for each of the plurality of compute nodes, an idle power level, an activation power level, and a dynamic power level, and identifying characteristics of a workload to be deployed in Cloud computing system. The operations also include identifying a plurality of locations in the Cloud computing system that are suitable for deployment of the workload based on the characteristics of a workload and the resource utilization levels for processors and memory of each of the plurality of compute nodes, where each of the plurality of locations is one of the plurality of compute nodes, calculating, for each of the plurality of locations based on a simulated deployment of the workload at a corresponding location, an estimated power consumption of the Cloud computing system, and deploying the workload on a first compute node, where the first compute node corresponds to one of the plurality of locations associated with a lowest estimated power consumption of the Cloud computing system. Technical benefits of deploying workloads in a Cloud computing system in the manner provided include improving the energy efficiency of the Cloud computing system by determining a deployment location of workloads based at least in part on an estimated total energy consumption of the Cloud computing system.

Existing methods for deploying a workload in a Cloud computing system are primarily designed to evenly distribute the workloads across the compute nodes such that the resource utilization levels of the compute nodes in the Cloud computing system are approximately equal. Current workload scheduling algorithms do not account for the energy efficiency of the placement of workloads within the Cloud computing systems.

In exemplary embodiments, methods for deploying and managing workloads in a Cloud computing system that are configured to minimize the energy consumed by the Cloud computing system are provided. In exemplary embodiments, a scheduling algorithm that is responsible for deploying a new workload in the Cloud computing system is configured to identify an energy efficient placement of workload in the Cloud computing system by identifying the compute node of the Cloud computing system that can execute the workload with incurring the smallest increase in energy consumed by the Cloud computing system. In addition, the scheduling algorithm is configured to periodically migrate workloads among the compute nodes of the Cloud computing system to ensure the Cloud computing system is operating in energy efficient manner.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as deploying a workload in a cloud computing, as shown at block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

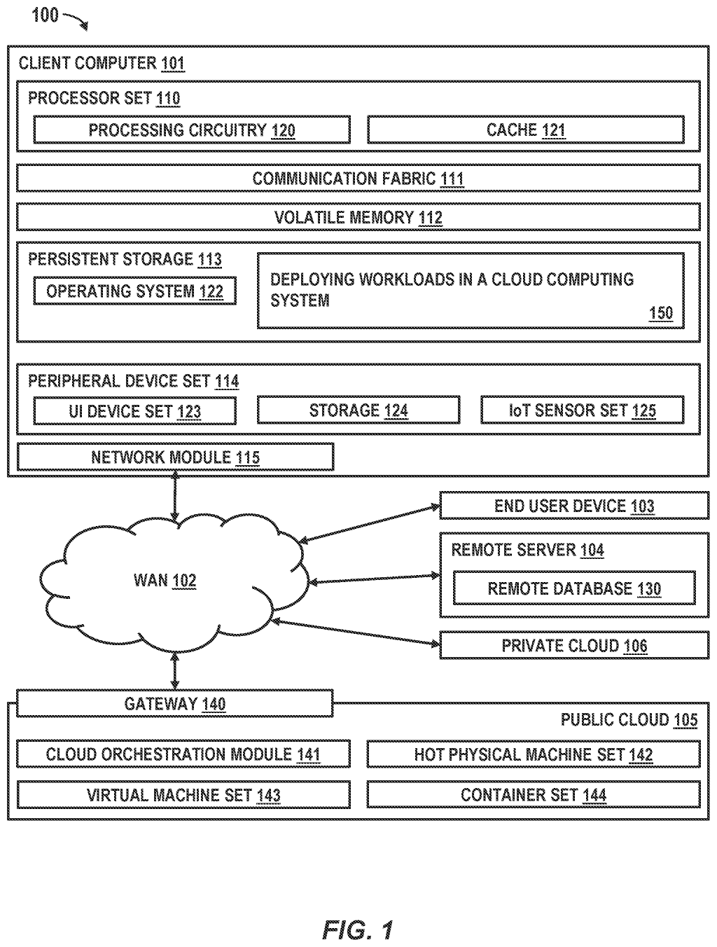

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

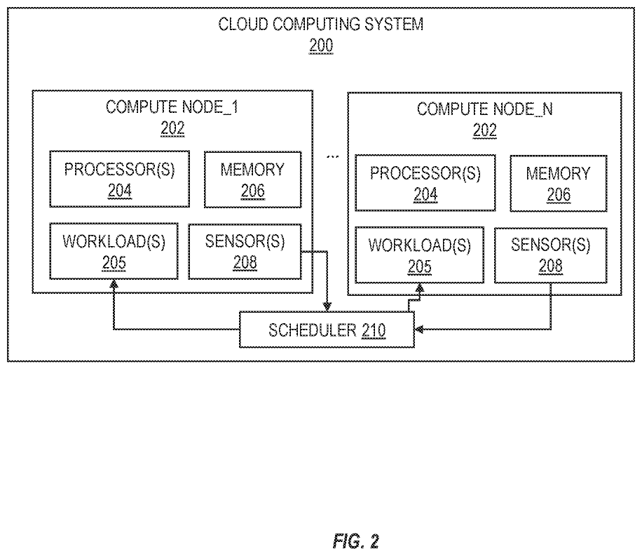

Referring now to FIG. 2, a cloud computing system 200 in accordance with one or more embodiments of the present disclosure is shown. As illustrated, the cloud computing system 200 includes a plurality of compute nodes 202 that each includes one or more processors 204, one or more memory devices 206, and one or more sensors 208. Each of the compute nodes 202 is configured to execute one or more workloads 205. In exemplary embodiments, the workloads 205 are configured to utilize the memory devices 206 and processors 204 and to execute on the compute nodes 202. In exemplary embodiments, the sensors 208 are configured to measure the energy consumption of the compute nodes 202 including the energy consumed by the processors 204 and the memory devices 206. In addition, the sensors 208 are configured to monitor the utilization rates of the processors 204 and the memory devices 206 of the compute node 202. The sensors 208 are further configured to measure the relative utilization of the processors 204 and the memory devices 206 by each of the workloads 205.

In exemplary embodiments, the frequency of collection of the utilization rates and corresponding energy usage level for compute node 202 is set by an administrator of the cloud computing system 200. In one embodiment, each sample collected by the sensors 208 includes an identification of the workloads 205 executing on the compute node 202, a compute node identifier, and a current energy usage level of the compute node 202. The current energy usage may be expressed in kilowatt-hours (kWh). The sensors 208 are configured to transmit the collected data from the compute nodes 202 to a scheduler 210 of the Cloud computing system 200.

In exemplary embodiments, the scheduler 210 is configured to control the deployment of workloads 205 to compute nodes 202. For example, the scheduler 210 is configured to deploy new workload 205 on compute nodes 202 of the Cloud computing system 200 and to migrate workloads 205 among the compute nodes 202 of the Cloud computing system 200. In exemplary embodiments, the scheduler 210 is configured to deploy and migrate the workloads 205 among the compute nodes 202 based on the ability of a compute node 202 to execute a specific workload (i.e., does the compute node 202 have sufficient available processing and memory resources) and based on the energy efficiency of placing a workload 205 on a compute node 202.

In exemplary embodiments, the scheduler 210 is configured to calculate various power metrics for each compute node 202 based on the collected power consumption data received from the sensors 208. The scheduler 210 is configured to calculate an idle power level for each compute node 202. The idle power is the minimal power that is used by a compute node 202 when the system is in an inactive state, (i.e., when the compute node 202 is in a low power or standby mode and is not executing any workloads). The idle power consumption is a constant value that includes static power losses resulting from the supply voltage.

In exemplary embodiments, the scheduler 210 is also configured to calculate an activation power level for each compute node 202 based on the collected power consumption data received from the sensors 208. The activation power level is the minimum amount of power consumed by a compute node 202 when it is operating in an active state. For example, the activation power level is the power consumption that is triggered by the first running processes, or workload 205, executing on the compute node 202. The activation power level remains constant regardless of the number of workloads 205 executing on a compute node and/or the activity level (e.g., event rate) of the workloads executing on the compute node. The activation power level includes power consumed by clocking circuity, voltage regulators, memory controllers, and other circuity of the compute nodes.

In exemplary embodiments, the scheduler 210 is also configured to calculate a dynamic power level of each compute node 202 based on the collected power consumption data received from the sensors 208. The dynamic power level is the power used by the compute node 202 that is dependent on the workloads executing on the compute node 202. For example, the dynamic power level is based on the level of resource utilization (e.g., the utilization rate of the processors 204 and memory devices 206 of the compute node 202) and based on the activity level (e.g., event rate) of the workloads 205 executing on the compute node 202.

In exemplary embodiments, the scheduler 210 is configured to measure the power consumed by each compute node 202 during active and inactive states and during periods having different activity levels. In one embodiment, the scheduler 210 calculates a per-process power consumption for each workload 205 based on the idle power level, the activation power level, and the dynamic power level of the compute node 202 that the workload is executing on and based on the activity level of the workload. By utilizing a per-process measured power consumption, the scheduler 210 can minimize the energy consumption of the Cloud computing system 200 by identifying the most energy efficient compute node 202 for the placement of each workload 205.

In one embodiment, when calculating an energy usage of a workload 205 on a compute node 202, the scheduler 210 evenly distributes the activation power level of the compute node among all of the workloads 205 executing on a compute node 202. In another embodiment, when calculating an energy usage of a workload 205 on a compute node 202, the scheduler 210 proportionally distributes the activation power level of the compute node among all of the workloads 205 executing on a compute node 202 based on the respective activity levels of workloads 205.

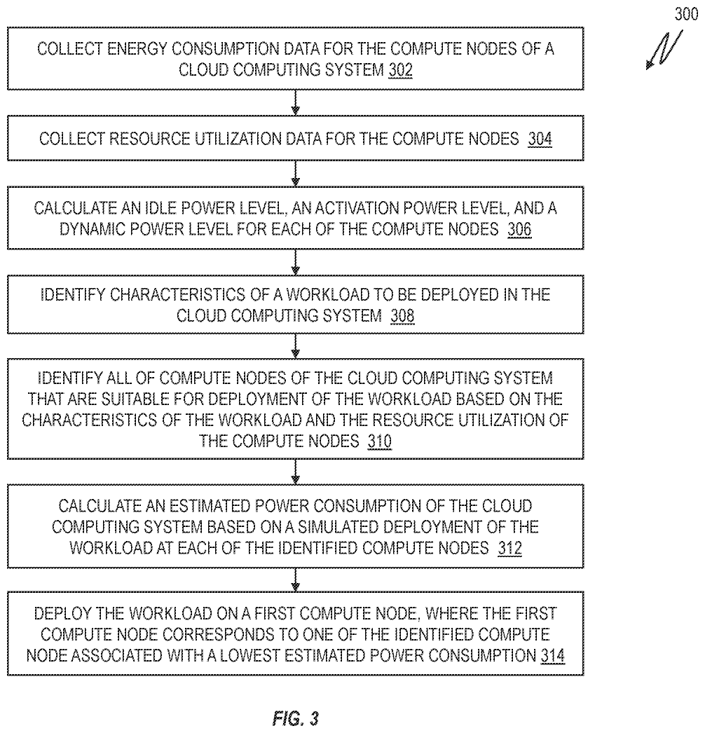

Referring now to FIG. 3, a flowchart of a method 300 for deploying a workload in a cloud computing system in accordance with one or more embodiments of the present disclosure is shown. As used herein the term Cloud computing system refers to any cloud computing system and may include a public cloud, a private could, and a combination of the two. In exemplary embodiments, the method 300 is performed by a scheduler 210 of a Cloud computing system 200 as shown in FIG. 2.

As shown at block 302, the method 300 includes collecting energy consumption data for the compute nodes of a cloud computing system. Next, as shown at block 304, the method 300 includes collecting resource utilization data for the compute nodes. In exemplary embodiments, the energy consumption data for compute nodes and the resource utilization data for the compute nodes are sampled periodically at a frequency set by an administrator of the cloud computing system.

As shown at block 306, the method 300 includes calculating an idle power level, an activation power level, and a dynamic power level for each of the compute nodes in the Cloud computing system. The idle power level is the amount of power used by a compute node in a standby state during which no workloads are being executed by the compute node. The activation power level is a minimum amount of power used by a compute node in an active state during which at least one workload is being executed by the compute node. The activation power level is a constant value that does not vary based on the resource utilization levels for processors and memory of the compute node. The dynamic power level is an amount of power used by a compute node during an active state (i.e., when at least one workload is being executed by the compute node). The activation power level is a dynamic value that is dependent upon the resource utilization levels for processors and memory of the compute node and the activity level of the workloads. In exemplary embodiments, the idle power level, the activation power level, and the dynamic power level for each of the plurality of compute nodes is calculated by based on a power consumption of each of the plurality of compute nodes during a standby state and during active states with varying resource utilization levels.

Next, as shown at block 308, the method 300 includes identifying characteristics of a workload to be deployed in the cloud computing system. In exemplary embodiments, the characteristics of the workload include the expected computing resources that are necessary to execute the workload and/or the expected activity level of the workload. For example, the characteristics of the workload may specify an amount of memory that is expected to be utilized by a workload and the number of operations per second that the workload is expected to perform. The method 300 also includes identifying all of compute nodes of the cloud computing system that are suitable for deployment of the workload based on the characteristics of the workload and the resource utilization of the compute nodes, as shown at block 310. In exemplary embodiments, a compute node is considered to be suitable for the deployment of a workload based on a determination that the compute node has sufficient available computing resources to execute the workload.

At block 312, the method 300 includes calculating an estimated power consumption of the Cloud computing system based on a simulated deployment of the workload at each of the identified compute nodes. In exemplary embodiments, the estimated power consumption of the Cloud computing system is calculated as a sum of the idle power level of each of the plurality of the compute nodes operating in a standby state, the activation power level of each of the plurality of the compute nodes operating in an active state, and the dynamic power level of each of the plurality of the compute nodes operating in a standby state. The method 300 concludes at block 314 by deploying the workload on the first compute node of the Cloud computing system, where the first compute node corresponds to the identified compute node associated with the lowest estimated power consumption of the Cloud computing system. In exemplary embodiments, a plurality of estimated power consumptions of the Cloud computing system are calculated based on the simulated deployment of the workload to various compute nodes and the lowest estimated power consumption of the Cloud computing system is identified as the plurality of estimated power consumptions having a lowest value.

In one example, a Cloud computing system includes a first compute node and a second compute node and the first compute node is executing a first workload. In this example, the second compute node is idle as it is not executing a workload. When a second workload is to be deployed in the Cloud computing system, the scheduler determines if both the first compute node and the second compute node are capable of executing the second workload. Based on a determination that both the first compute node and the second compute node are capable of executing the second workload, the scheduler calculates the estimated power consumption of the Cloud computing system associated with deploying the second workload on the first compute node (i.e., maintaining the second compute node in an idle or standby state) and the estimated power consumption of the Cloud computing system associated with deploying the second workload on the second compute node (i.e., activating the second compute node). The scheduler then deploys the second workload based on the simulated deployment that corresponds to the lowest total energy consumption of the Cloud computing system.

In exemplary embodiments, the method 300 may also include calculating the power consumption of the workload. In one embodiment, the power consumption of a workload is calculated by evenly dividing the activation power level of the first compute node among workloads being processed by the first compute node and apportioning the dynamic power level among the workloads being processed by the first compute node based on the resource utilization levels of each of the workloads being processed by the first compute node.

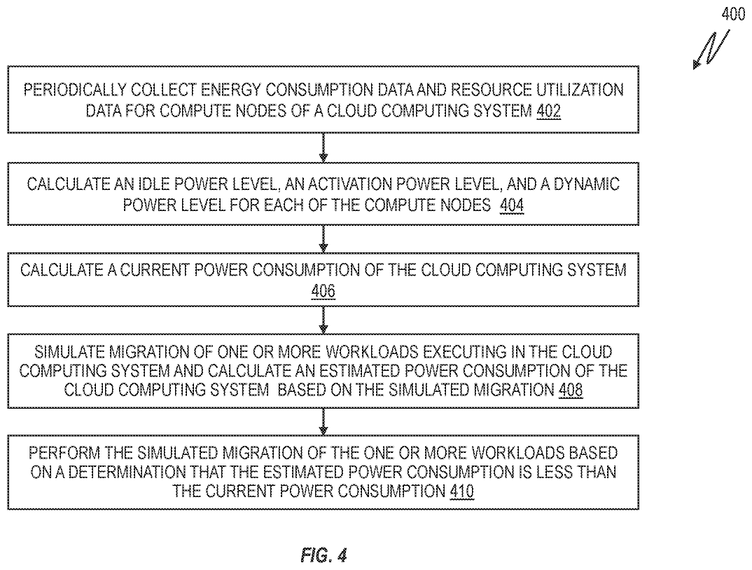

Referring now to FIG. 4, a flowchart of a method 400 for estimating the energy consumption of a workload in a cloud computing system in accordance with one or more embodiments of the present disclosure is shown. As used herein the term Cloud computing system refers to any cloud computing system and may include a public cloud, a private could, and a combination of the two. In exemplary embodiments, the method 300 is performed by a scheduler 210 of a Cloud computing system 200 as shown in FIG. 2.

As shown at block 402, the method 400 includes periodically collecting energy consumption data and resource utilization data for compute nodes of a cloud computing system. In exemplary embodiments, the energy consumption data for compute nodes and the resource utilization data for the compute nodes are sampled periodically at a frequency set by an administrator of the Cloud computing system. Next, as shown at block 404, the method 400 includes calculating an idle power level, an activation power level, and a dynamic power level for each of the compute nodes.

The method 400 also includes calculating the current power consumption of the Cloud computing system, as shown at block 406. In exemplary embodiments, the current power consumption of the Cloud computing system is calculated as a sum of the idle power level of each of the plurality of the compute nodes operating in a standby state, the activation power level of each of the plurality of the compute nodes operating in an active state, and the dynamic power level of each of the plurality of the compute nodes operating in a standby state.

Next, as shown at block 408, the method 400 includes simulating the migration of one or more workloads executing in the cloud computing system and calculating an estimated power consumption of the Cloud computing system based on the simulated migration. In exemplary embodiments, a plurality of simulations that each include moving workloads to/from various compute nodes may be simultaneously and/or iteratively performed to identify an optimal deployment of the workloads among the compute nodes of the Cloud computing system. The optimal deployment of the workloads among the compute nodes of the Cloud computing system is the deployment of the workloads that results in the lowest estimated power consumption of the Cloud computing system. The method 400 concludes at block 410 by performing the simulated migration of one or more workloads based on a determination that the estimated power consumption is less than the current power consumption.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for deploying a workload in a Cloud computing system having a plurality of compute nodes, the method comprising:
identifying resource utilization levels for processors and memory of each of the plurality of compute nodes;
calculating, for each of the plurality of compute nodes, an idle power level, an activation power level, and a dynamic power level;
identifying characteristics of the workload to be deployed in Cloud computing system;
identifying a plurality of locations in the Cloud computing system that are suitable for deployment of the workload based on the characteristics of the workload and the resource utilization levels for processors and memory of each of the plurality of compute nodes, wherein each of the plurality of locations is one of the plurality of compute nodes;
calculating, for each of the plurality of locations based on a simulated deployment of the workload at a corresponding location, an estimated power consumption of the Cloud computing system; and
deploying the workload on a first compute node, where the first compute node corresponds to one of the plurality of locations associated with a lowest estimated power consumption of the Cloud computing system.

2. The computer-implemented method of claim 1, wherein the idle power level is an amount of power used by a compute node in a standby state during which no workloads are being executed by the compute node.

3. The computer-implemented method of claim 1, wherein the activation power level is a minimum amount of power used by a compute node in an active state during which at least one workload is being executed by the compute node and wherein the activation power level is a constant value that does not vary based on the resource utilization levels for processors and memory of the compute node.

4. The computer-implemented method of claim 1, wherein the dynamic power level is an amount of power used by a compute node in an active state during which at least one workload is being executed by the compute node and wherein the activation power level is a dynamic value that is dependent upon the resource utilization levels for processors and memory of the compute node.

5. The computer-implemented method of claim 1, wherein the idle power level, the activation power level, and the dynamic power level for each of the plurality of compute nodes is calculated by based on a power consumption of each of the plurality of compute nodes during a standby state and during active states with varying resource utilization levels.

6. The computer-implemented method of claim 1, wherein the estimated power consumption of the Cloud computing system is calculated as a sum of:
the idle power level of each of the plurality of the compute nodes operating in a standby state;
the activation power level of each of the plurality of the compute nodes operating in an active state; and
the dynamic power level of each of the plurality of the compute nodes operating in a standby state.

7. The computer-implemented method of claim 1, further comprising calculating a power consumption of the workload by:
evenly dividing the activation power level of the first compute node among workloads being processed by the first compute node; and
apportioning the dynamic power level among the workloads being processed by the first compute node based on the resource utilization levels of each of the workloads being processed by the first compute node.

8. A computing system having a memory having computer readable instructions and one or more processors for executing the computer readable instructions, the computer readable instructions controlling the one or more processors to perform operations comprising:
identifying resource utilization levels for processors and memory of each of a plurality of compute nodes in a Cloud computing system;
calculating, for each of the plurality of compute nodes, an idle power level, an activation power level, and a dynamic power level;
identifying characteristics of a workload to be deployed in Cloud computing system;
identifying a plurality of locations in the Cloud computing system that are suitable for deployment of the workload based on the characteristics of the workload and the resource utilization levels for processors and memory of each of the plurality of compute nodes, wherein each of the plurality of locations is one of the plurality of compute nodes;
calculating, for each of the plurality of locations based on a simulated deployment of the workload at a corresponding location, an estimated power consumption of the Cloud computing system; and
deploying the workload on a first compute node, where the first compute node corresponds to one of the plurality of locations associated with a lowest estimated power consumption of the Cloud computing system.

9. The computing system of claim 8, wherein the idle power level is an amount of power used by a compute node in a standby state during which no workloads are being executed by the compute node.

10. The computing system of claim 8, wherein the activation power level is a minimum amount of power used by a compute node in an active state during which at least one workload is being executed by the compute node and wherein the activation power level is a constant value that does not vary based on the resource utilization levels for processors and memory of the compute node.

11. The computing system of claim 8, wherein the dynamic power level is an amount of power used by a compute node in an active state during which at least one workload is being executed by the compute node and wherein the activation power level is a dynamic value that is dependent upon the resource utilization levels for processors and memory of the compute node.

12. The computing system of claim 8, wherein the idle power level, the activation power level, and the dynamic power level for each of the plurality of compute nodes is calculated by based on a power consumption of each of the plurality of compute nodes during a standby state and during active states with varying resource utilization levels.

13. The computing system of claim 8, wherein the estimated power consumption of the Cloud computing system is calculated as a sum of:
the idle power level of each of the plurality of the compute nodes operating in a standby state;
the activation power level of each of the plurality of the compute nodes operating in an active state; and
the dynamic power level of each of the plurality of the compute nodes operating in a standby state.

14. The computing system of claim 8, wherein the operations further comprise calculating a power consumption of the workload by:
evenly dividing the activation power level of the first compute node among workloads being processed by the first compute node; and
apportioning the dynamic power level among the workloads being processed by the first compute node based on the resource utilization levels of each of the workloads being processed by the first compute node.

15. A computer program product comprising a computer readable storage medium having program instructions embodied therewith, the program instructions executable by a processor to cause the processor to perform operations comprising:
identifying resource utilization levels for processors and memory of each of a plurality of compute nodes in a Cloud computing system;
calculating, for each of the plurality of compute nodes, an idle power level, an activation power level, and a dynamic power level;
identifying characteristics of a workload to be deployed in Cloud computing system;
identifying a plurality of locations in the Cloud computing system that are suitable for deployment of the workload based on the characteristics of the workload and the resource utilization levels for processors and memory of each of the plurality of compute nodes, wherein each of the plurality of locations is one of the plurality of compute nodes;
calculating, for each of the plurality of locations based on a simulated deployment of the workload at a corresponding location, an estimated power consumption of the Cloud computing system; and
deploying the workload on a first compute node, where the first compute node corresponds to one of the plurality of locations associated with a lowest estimated power consumption of the Cloud computing system.

16. The computer program product of claim 15, wherein the idle power level is an amount of power used by a compute node in a standby state during which no workloads are being executed by the compute node.

17. The computer program product of claim 15, wherein the activation power level is a minimum amount of power used by a compute node in an active state during which at least one workload is being executed by the compute node and wherein the activation power level is a constant value that does not vary based on the resource utilization levels for processors and memory of the compute node.

18. The computer program product of claim 15, wherein the dynamic power level is an amount of power used by a compute node in an active state during which at least one workload is being executed by the compute node and wherein the activation power level is a dynamic value that is dependent upon the resource utilization levels for processors and memory of the compute node.

19. The computer program product of claim 15, wherein the idle power level, the activation power level, and the dynamic power level for each of the plurality of compute nodes is calculated by based on a power consumption of each of the plurality of compute nodes during a standby state and during active states with varying resource utilization levels.

20. The computer program product of claim 15, wherein the estimated power consumption of the Cloud computing system is calculated as a sum of:
the idle power level of each of the plurality of the compute nodes operating in a standby state;
the activation power level of each of the plurality of the compute nodes operating in an active state; and
the dynamic power level of each of the plurality of the compute nodes operating in a standby state.
